(19) United States
(12) Patent Application Publication
(10) Pub. No.: US 2026/0244431 A1
(43) Pub. Date: Aug. 20, 2026

(54) COMMON METHOD FOR PASSING USER DATA IN A VIRTUAL ENVIRONMENT

(71) Applicant: Hewlett Packard Enterprise Development LP, Spring, TX (US)

(72) Inventors: Surendra Babu Akula, Bangalore (IN); Murulikrishna Budhya Annajirao, Bangalore (IN); Krishna Chaitanya Battini, Bangalore (IN); Kenneth Eugene James, Fort Collins, CO (US)

(21) Appl. No.: 19/171,473

(22) Filed: Apr. 7, 2025

(30) Foreign Application Priority Data
Feb. 14, 2025 (IN) 202511012862

(51) Int. Cl. G06F 8/65; G06F 9/455

(52) U.S. Cl. CPC G06F 8/65; G06F 9/45558; G06F 2009/45562

(57) ABSTRACT

A common method is provided for passing user data in a virtual environment. A system creates, by a tool or program that runs on a hypervisor associated with a plurality of virtual machines (VMs), a data file comprising user data associated with deployment of a VM. The system obtains an output International Standard for Organization (ISO) by creating a copy of a template ISO image. The system updates the ISO image based on the data file, the output ISO image corresponding to a storage medium (e.g., a compact disc/digital versatile disc (CD/DVD)) accessible to a data-reading module of the VM. The system deploys the VM based on the updated output ISO image. The system allows access by the VM to the user data by invoking a call to the data-reading module without requiring hypervisor-specific configuration information.

### BACKGROUND

### Field

Virtual machines (VMs) can be deployed by a hypervisor on a virtualized environment. This deployment generally requires specific underlying hardware, software, firmware, and physical server configuration. In addition, each VM may require certain custom configuration parameters or “user data” from the underlying hypervisor. Each hypervisor may use a different method and format to pass the user data to a deployed VM. As a result, a VM module which accesses the passed user data must identify the underlying hypervisor, parse the format and procedure in which the user data is passed to the VM, and invoke the corresponding data access module to read the user data.

### BRIEF DESCRIPTION OF THE FIGURES

FIG. 1 illustrates a diagram of an environment which facilitates a common method for passing user data in a virtual environment, in accordance with an aspect of the present application.

FIG. 2 depicts a table illustrating sample user data, in accordance with an aspect of the present application.

FIG. 3 presents a flowchart illustrating a method which facilitates passing user data in a virtual environment, in accordance with an aspect of the present application.

FIG. 4 illustrates a diagram of sample display screens in a system which facilitates a common method for passing user data in a virtual environment, in accordance with an aspect of the present application.

FIG. 5 illustrates a computer system which facilitates a common method for passing user data in a virtual environment, in accordance with an aspect of the present application.

FIG. 6 illustrates a computer-readable medium which facilitates a common method for passing user data in a virtual environment, in accordance with an aspect of the present application.

In the figures, like reference numerals refer to the same figure elements.

### DETAILED DESCRIPTION

The following description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

The described aspects provide a common method or mechanism for passing user data in a virtual environment. The common method may achieve hypervisor independence for passing user data, i.e., deploying a VM by passing user data in a common manner without the need to specifically identify the underlying hypervisor or use the hypervisor's specific method of passing the user data. Achieving hypervisor independence for passing user data may increase efficiency when passing user data to VMs from an increasing number of different hypervisors.

As described above, a hypervisor can deploy a VM on a virtualized environment, and the deployment generally requires specific underlying hardware, software, firmware, and physical server configuration. Each VM may require certain custom configuration parameters or “user data” from the underlying hypervisor. The user data may include, e.g., the IP address of the VM instance, the number of cores on which the VM is to run, the underlying central processing unit (CPU) clock frequency, etc. Each hypervisor may use a different method and format to pass the user data to a deployed VM. As a result, a VM which accesses the passed user data must identify the underlying hypervisor, parse the format and procedure in which the user data is passed to the VM, and invoke the corresponding data access module to read the user data.

Existing hypervisors use different methods to pass user data in order to deploy VMs. For example, one existing hypervisor can allow the user to pass the user data by setting VM-specific information using a “guestinfo. <variable>” file, which can support multiple key/value pairs. This hypervisor can also allow a user to pass the user data by setting the VM-specific information using a “machine.id” file. This machine. id file may not support multiple key/value pairs and instead may require the user to specify all the parameters as a string (e.g., machine.id=<string>).

Another existing hypervisor can allow the user to pass the user data to a VM in International Standard for Organization (ISO) or disk format and to subsequently pass the location of the ISO or disk file in an eXtensible Markup Language (XML) configuration file. A tool or program that runs on the hypervisor first creates a sample CPU user data format in a text file and then converts the text file to ISO format or saves the ISO format in disk so that the hypervisor passes the converted text file to a VM.

Yet another existing hypervisor can allow the user to pass the user data by creating a shared network folder, using a PowerShell “cmdlet” (i.e., a script which performs a specific single function) to copy files, mounting the virtual hard disk to the host machine, and using an enhanced session mode to copy files from the host to the VM. These are non-limiting examples, and other hypervisors may use different methods to pass the user data while deploying the VMs.

Thus, a VM that is deployed over a specific hypervisor must comply with the underlying hypervisor to implement logic to access the user data passed to the VM. That is, the VM must have knowledge of the underlying hypervisor, understand the format and procedure in which the user data is passed to the VM, and invoke the corresponding data access module to read the user data. Because each hypervisor may use a different method to pass the user data, the VM must retrieve the user data by implementing a different logic to support a respective different method of each hypervisor. The dependence on knowledge of the underlying hypervisor may decrease efficiency in light of the increasing number of different hypervisors and virtual platforms.

The described aspects address the above-described limitations by providing a common method for passing data in a virtualized environment. Using the common method described herein may result in hypervisor independence, which can result in an improvement in scalability and performance when deploying VMs using user data in a virtual environment. A tool or program that runs on a hypervisor (or a user) can create a user data file which contains information to be accessed by a VM and used to configure basic VM parameters after the VM is provisioned. The tool or program that runs on the hypervisor can update VM-specific user data in an output ISO image file that is a copy of a read-only template ISO image file. The hypervisor can pass the user data to the VM by (1) deploying each VM with a corresponding updated ISO image mapped to the VM file system as CD/DVD media, and (2) mounting the CD/DVD device inside the VM. Based on this common format, the VM can subsequently invoke a single common data-reading module to access the user data passed by the underlying hypervisor, thus allowing the VM to read the user data from a common module without the need to perform any hypervisor-specific operations.

This common method of passing user data, which allows a VM to read the user data independent of the specific hypervisor, may reduce complexity in VMs. For example, a software platform that allows users to deploy mission-critical applications in a private cloud may be seamlessly deployed on all cloud providers because the described method can run on any native hypervisor of a cloud provider.

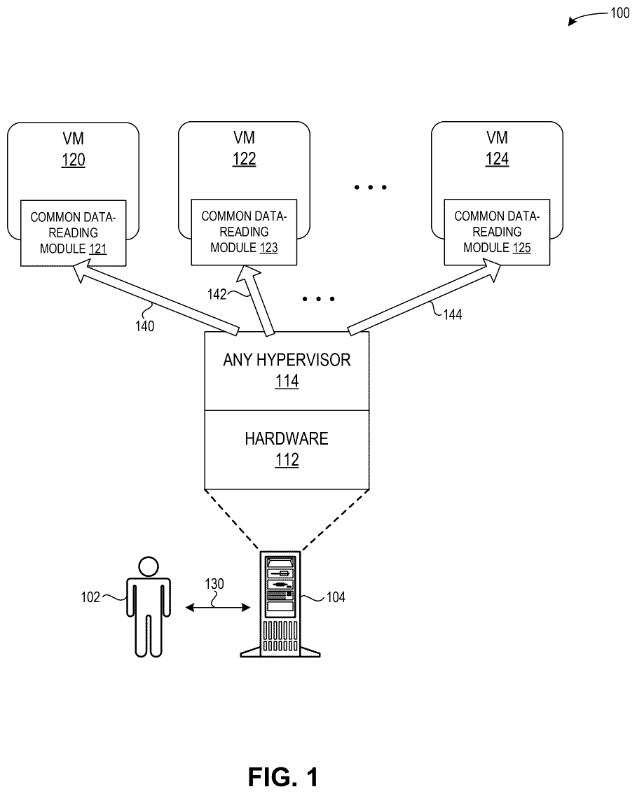

FIG. 1 illustrates a diagram of an environment 100 which facilitates a common method for passing user data in a virtual environment, in accordance with an aspect of the present application. Environment 100 can include a user 102 and an associated computing device 104. Computing device 104 may be a server, computing system, host device, or other device which can include hardware 112 (e.g., server hardware 112). Computing device 112 can also include any hypervisor 114, which can be a program in software, firmware, or hardware that creates and runs virtual machines (VMs). For example, any hypervisor 114 may deploy and run a plurality of VMs (e.g., a VM 120, a VM 122, and a VM 124). Each of VMs 120, 122, and 124 may have a common data-reading module (e.g., respectively, 121, 123, and 125). The number of VMs depicted in FIG. 1 is provided for illustrative purposes only. Any number or plurality of VMs may be deployed by hypervisor 114.

During operation, a tool or program that runs on hypervisor 114 (or user 102 via a communication 130 with hypervisor 114) may create a sample user data file for a VM in a format such as:
728069 1 0 167863040 9 1 2 2095170000

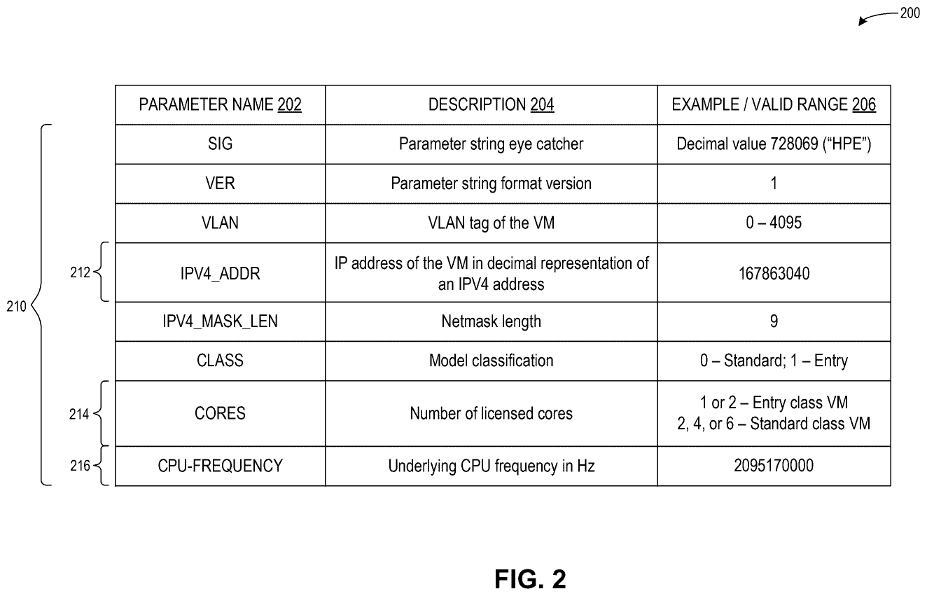

The content of the sample user parameter file may be as indicated below in table 200 of FIG. 2, and the file may be given a name such as “CPU00.udata.”

The template ISO image can be created once and may be accomplished using a software tool that generates an ISO image compliant with the ISO 9660 standard and distributed along with deployment tools. This template ISO image (e.g., “CPU.config.iso”) can be a read-only input file and may be distributed along with the deployment tools. A tool or program that runs on hypervisor 114 may subsequently create a copy of this read-only template ISO image to obtain an output ISO image file with the name of the VM instance and may further update the user data content in the output ISO image file with the required data for the VM instance. The tool or program that runs on hypervisor 114 may use the output ISO image file each time, instead of using third party tools to generate the ISO image, thus eliminating the need to create an ISO image each time a VM is to be deployed.

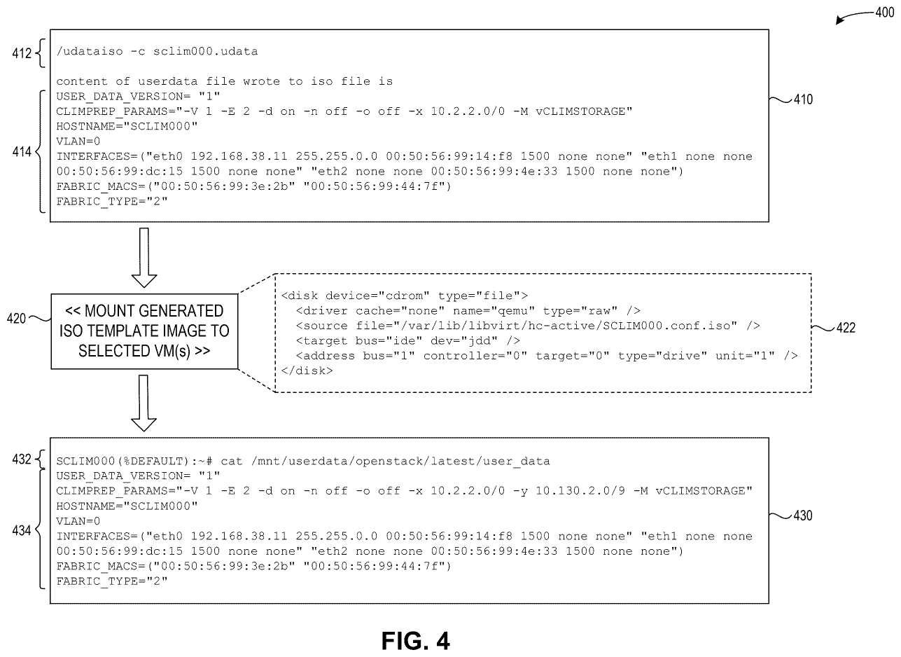

For example: “CPU00.config.iso” may be the output ISO image file to be used for the instance corresponding to VM 120 (e.g., with the name “CPU00” for the instance of this VM); “CPU01.config.iso” may be the output ISO image file to be used for the instance corresponding to VM 122 (e.g., with the name “CPU01” for the instance of this VM); and “CPU02.config.iso” may be the output ISO image to be used for the instance corresponding to VM 124 (e.g., with the name “CPU02” for the instance of this VM). A sample display screen indicating usage of a software tool, creating a copy of an ISO template, and updating the user data with the required user data of a VM instance (output ISO image file) is described below in relation to FIG. 4.

Hypervisor 114 may deploy each VM with the corresponding output ISO image of the user data mapped as CD/DVD storage medium to the VM file system in order to pass user data to the VM. For example: hypervisor 114 may deploy VM 120 with the updated output ISO image file named CPU00.config. iso (via a communication 140); hypervisor 114 may deploy VM 122 with the updated output ISO image file named CPU01.config.iso (via a communication 142); and hypervisor 114 may deploy VM 124 with the updated output ISO image file named CPU02.config.iso (via a communication 144). Hypervisor 114 may also pass, to VMs 120, 122, and 124 (via, respectively, communications 140, 142, and 144) the location of the updated output ISO image in a configuration file.

A respective VM can mount the CD/DVD and invoke the single common data-reading module to read the data, and hypervisor 114 may map the CD/DVD to the VM while deploying the VM. Hypervisor 114 may use any user interface (e.g., graphical or command line) to deploy the VM, as described below in relation to FIG. 4. As a result of mounting the CD/DVD storage medium inside a VM, the VM need only invoke the call to the common data-reading module. For example, subsequent to communication 140 (i.e., deploying VM 120 based on the corresponding updated output ISO image CPU00.config.iso), VM 120 may invoke common data-reading module 121 to read the contents of the output ISO image based on the mapping as a CD/DVD storage medium. Similarly, subsequent to communication 142 (i.e., deploying VM 122 based on the corresponding updated output ISO image CPU01.config.iso), VM 122 may invoke its common data-reading module 123 to read the contents of the output ISO image based on the mapping of the output ISO image to the VM file system as a CD/DVD storage medium. In addition, subsequent to communication 144 (i.e., deploying VM 124 based on the corresponding updated output ISO image CPU02.config.iso), VM 124 may invoke its common data-reading module 125 to read the contents of the output ISO image based on the mapping as a CD/DVD storage medium. As a result, VMs 120, 122, and 124 do not need to know about hypervisor 114, including the specific type of hypervisor or any format or procedure in which the user data is passed to a VM by the specific type of hypervisor.

Thus, the described aspects can achieve hypervisor independence by performing a one-time creation of an ISO template image that is read-only, copying the ISO template image to an output ISO image with the name of the VM instance, updating the output ISO image with user data for a particular instance of a VM, and deploying the VM based on the updated output ISO image file. The updated output ISO image with the name of the VM instance can be mapped or correspond to a CD/DVD storage medium accessible to a common data-reading module of the VM, which allows access by the VM to the user data by invoking a call to the respective data-reading module without requiring hypervisor-specific configuration information.

FIG. 2 depicts a table 200 illustrating sample user data, in accordance with an aspect of the present application. Table 200 includes entries (rows) 210 with the following fields (columns): a parameter name 202; a description 204; and an example/valid range 206. Entries 210 in table 200 may include user data such as, but not limited to: an identifier of a parameter associated with the VM (“SIG”); a version of the parameter (“VER”); a virtual local area network (VLAN) tag associated with the VM (“VLAN”); an Internet Protocol (IP) address of the VM (“IPV4_ADDR”); a length of a netmask associated with the VM (“IPV4_MASK_LEN”); a model classification associated with the VM (“CLASS”); a number of licensed cores allocated to the VM (“CORES”); or an underlying clock frequency of a central processing unit (CPU) associated with the VM (“CPU-FREQUENCY”).

For example, an entry 212 indicates that for a parameter name of “IPV4_ADDR”), the description is “IP address of the VM in decimal representation of an IPV4 address” and an example/valid range is “167863040.” As another example, an entry 214 indicates that for a parameter name of “CORES,” the description is “Number of licensed cores” and an example/valid range is “1 or 2 for an Entry class VM” or “2, 4, or 6 for a Standard class VM.” As yet another example, an entry 216 indicates that for a parameter name of “CPU-FREQUENCY,” the description is “Underlying CPU frequency in Hertz (Hz)” and an example/valid range is “2095170000.”

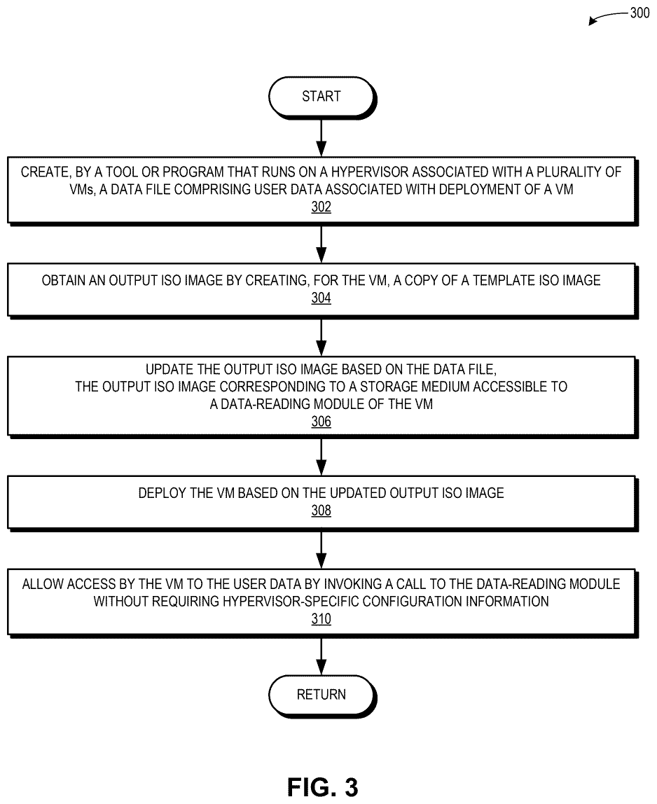

FIG. 3 presents a flowchart 300 illustrating a method which facilitates passing user data in a virtual environment, in accordance with an aspect of the present application. During operation, the system creates, by a tool or program that runs on a hypervisor associated with a plurality of virtual machines (VMs), a data file comprising user data associated with deployment of a VM (operation 302). As described above in relation to hypervisor 114 of FIG. 1 and table 200 of FIG. 2, the sample user data file for a VM may be in the following format and the file may be named, e.g., “CPU00.udata”:
728069 1 0 167863040 9 1 2 2095170000

The system obtains an output ISO image by creating, for the VM, a copy of a template ISO image (operation 304). The system may create a sample data file comprising sample user data in a format readable by the VM. A tool or program may also perform a one-time generation of the template ISO image based on the sample data file. For example, as described above in relation to FIG. 1, a tool or program that runs on hypervisor 114 may create or generate a template ISO image “CPU.config.iso.” A tool or program may create or generate this template ISO image only once and distribute this template ISO image along with deployment tools. A tool or program that runs on hypervisor 114 may subsequently create a copy of this read-only template ISO image to obtain the output ISO image file with the name of the VM instance.

The system updates the output ISO image based on the data file, the output ISO image corresponding to a storage medium (e.g., a compact disc/digital versatile disc (CD/DVD)) accessible to a data-reading module of the VM (operation 306). Updating the output ISO image based on the user data in the data file may be performed based on editing the output ISO image using a computer program, and the system may also rename the updated output ISO image based on the name of a specific VM instance, as described above in relation to VMs 120, 122, and 124 (e.g., respectively, renamed output ISO images CPU00.config.iso, CPU01.config.iso, and CPU02.config.iso). The updated output ISO image may correspond or be mapped to a CD/DVD storage medium accessible to a data-reading module of the VM, as described above in relation to common data-reading modules 121, 123, and 125 in, respectively, VMs 120, 122, and 124 of FIG. 1.

A sample display screen depicting the generation of a new user data file is provided below in relation to FIG. 4. The system can generate all subsequent output ISO images for a respective VM by updating the output ISO image based on a respective data file comprising respective user data to be used by a respective VM upon deployment of the respective VM.

The system deploys the VM based on the updated output ISO image (operation 308). The hypervisor may pass, to the VM, the user data via the updated output ISO image, and the hypervisor may also pass, to the VM, a location of the updated output ISO image in a configuration file, as described above in relation to communications 140, 142, and 144 in FIG. 1. For example, hypervisor 114 in FIG. 1 may deploy VM 120 by mounting the CD/DVD storage medium corresponding to the updated output ISO image file named CPU00.config.iso inside VM 120.

The system allows access by the VM to the user data by invoking a call to the data-reading module without requiring hypervisor-specific configuration information (operation 310). As a result of mounting the CD/DVD storage medium inside the VM, the system (i.e., the common method used by any hypervisor described herein) can allow the VM to invoke the call to its respective data-reading module without requiring any knowledge of configuration information specific to the hypervisor, thus achieving hypervisor independence. The VM does not need to identify the underlying hypervisor, nor does the VM need to parse the format and procedure in which the user data is passed to the VM. This is an improvement over the prior systems, in which each hypervisor uses a different method of passing data and the VM must have knowledge of the specific method used by the specific hypervisor (e.g., setting VM-specific information using a “guest-info. <variable>” file, creating a shared network folder using an enhanced session mode to copy files from host to VM, etc.).

FIG. 4 illustrates a diagram 400 of sample display screens 410, 420, and 430 in a system which facilitates a common method for passing user data in a virtual environment, in accordance with an aspect of the present application. Display screen 410 depicts the results of executing a command (as indicated in a section 412 of display screen 410) which runs a tool that creates a template ISO image, creates a copy of the template ISO image (“output ISO image”), and updates the output ISO image with a user data file, resulting in an updated output ISO image. For example, the tool may convert *.udata user data files into *.config.iso files which are compliant with the ISO 9660 standard, as described above in relation to operations 302, 304, and 306 of FIG. 3. The system may integrate this template ISO image creation tool with deployment tools which generate the required *config. iso file used to deploy a plurality of VMs. The updated user data information written to the updated output ISO image is indicated in a section 414 of display screen 410. Display screen 410 can correspond to operations 302-306 of FIG. 3.

Display screen 420 can correspond to operation 308 of FIG. 3, i.e., deploying the VM based on the updated output ISO image by mounting the updated output ISO image as a CD/DVD inside the VM. Hypervisors may use different tools to perform this mounting process. For example, the VMWare ESXi hypervisor may mount the generated and updated output ISO image by using a graphical user interface (GUI) for editing settings. The GUI of VMWare ESXi may display information relating to a specific VM in rows, such as information related to network adapters, storage media, status, and controller location. The GUI may also allow a user to map the updated output ISO image as CD/DVD media by browsing for the updated output ISO image on the server itself.

As another example, the Linux KVM hypervisor may use the command-line code indicated in display 422 to mount the updated output ISO image to the CD/DVD storage medium of a VM.

As yet another example, the Microsoft Hyper-V hypervisor may mount the generated and updated output ISO image by using a GUI for editing settings, where hardware components associated with a specific VM may be listed in a hierarchical format. For example, the associated hardware displayed in the Hyper-V GUI may include memory, processors, IDE controllers, a SCSI controller, network adapters, ports, and a diskette drive. A user may select a hardware component using the GUI, and information may appear on a separate pane of the GUI, including what media to use with the virtual CD/DVD drive. Options for the type of media to use in the Hyper-V GUI may include “None,” “Image file,” or “Physical CD/DVD drive.” The GUI may allow the user to select “Image file” and further to map the updated output ISO image as CD/DVD media by browsing for the updated output ISO image on media accessible to the hypervisor.

Regardless of how a specific hypervisor mounts the output ISO image to the CD/DVD storage medium of the VM, display screen 430 depicts how the user data is read by the VM using a method common to all hypervisors (e.g., any hypervisor 114 in FIG. 1). Section 432 indicates accessing the common data-reading module. Section 434 (similar to section 414 of display screen 410) indicates the user data information written to the updated output ISO image which was mounted in the VM.

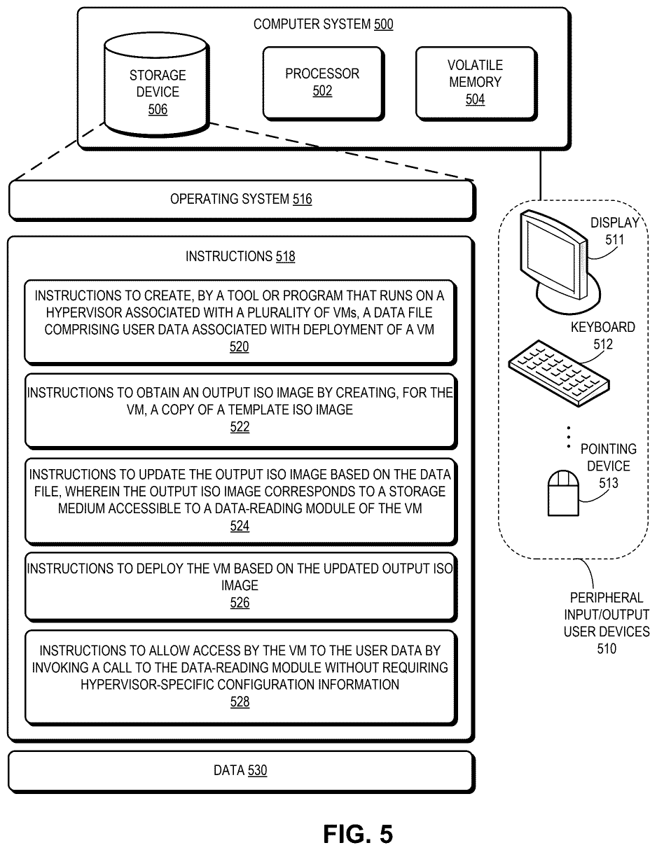

FIG. 5 illustrates a computer system 500 which facilitates a common method for passing user data in a virtual environment, in accordance with an aspect of the present application. Computer system 500 includes at least one processing resource (e.g., a processor 502), a memory 504, and a storage device 506. Memory 504 may include a volatile memory (e.g., random access memory (RAM)) that serves as a managed memory and can be used to store one or more memory pools. Furthermore, computer system 500 may be coupled to peripheral I/O user devices 510 (e.g., a display device 511, a keyboard 512, and a pointing device 513). Storage device 506 includes non-transitory computer-readable storage medium and stores an operating system 516, instructions 518, and data 530. Computer system 500 may include circuitry such as modules, units, components, etc. in hardware, software, or a combination of hardware and software (e.g., 506) to perform the methods and operations described herein. In computer system 500, the circuitry or storage device may store instructions which when executed by the at least one processing resource (e.g., 502) comprises instructions to perform the operations described herein. Computer system 500 may include fewer or more entities or instructions than those shown in FIG. 5.

Instructions 518 can include instructions, which when executed by computer system 500, can cause computer system 500 to perform methods and/or processes described in this disclosure. Specifically, instructions 518 may include instructions 520 to create, by a tool or program that runs on a hypervisor associated with a plurality of virtual machines (VMs), a data file comprising user data associated with deployment of a VM, as described above in relation to hypervisor 114 of FIG. 1, operation 302 of FIG. 3, and display screen 410 of FIG. 4.

Instructions 518 may include instructions 522 obtain an output ISO image by creating, for the VM, a copy of a template ISO image, as described above in relation to hypervisor 114 of FIG. 1, operation 304 of FIG. 3, and display screen 410 of FIG. 4.

Instructions 518 may include instructions 524 to update the output ISO image based on the data file, wherein the output ISO image corresponds to a storage medium (e.g., a CD/DVD) accessible to a data-reading module of the VM. Updating the ISO image based on the data file is described above in relation to hypervisor 114 of FIG. 1, operation 306 of FIG. 3, and display screen 410 of FIG. 4.

Instructions 518 may include instructions 526 to deploy the VM based on the updated output ISO image, as described above in relation to communications 140, 142, and 144 by hypervisor 114 of FIG. 1, operation 308 of FIG. 3, and display screen 420 and sample Linux KVM code 422 of FIG. 4.

Instructions 518 may include instructions 528 to allow access by the VM to the user data by invoking a call to the data-reading module without requiring hypervisor-specific configuration information, as described above in relation to common data-reading modules 121, 123, and 125 of, respectively, VMs 120, 122, and 124 of FIG. 1, operation 310 of FIG. 3, and display screen 430 of FIG. 4.

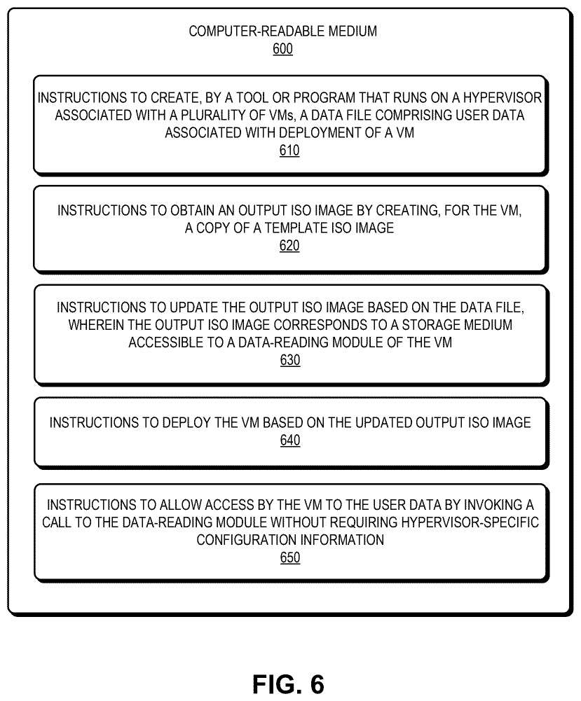

Instructions 518 may include more instructions than those shown in FIG. 5. For example, instructions 518 may include instructions for executing the operations described above in relation to: the environment of FIG. 1; the operations of flowchart 300 in FIG. 3; the operations associated with the display screens in FIG. 4; and the instructions of CRM 600 of FIG. 6.

Data 530 can include any data that is required as input or that is generated as output by the methods, operations, communications, and/or processes described in this disclosure. Specifically, data 530 can store at least: user data; an indicator of a hypervisor or a VM; a file containing user data; a sample data file; a file with sample user data in a format readable by a VM; an ISO image; a template ISO image; a copy of a template ISO image; an updated ISO image; an output ISO image; an updated output ISO image; a renamed template or output ISO image; an indicator of a call to a data-reading module; configuration or deployment information associated with a virtual machine; an identifier of a parameter associated with the VM; a version of the parameter; a virtual local area network (VLAN) tag associated with the VM; an IP address of the VM; a length of a netmask associated with the VM; a model classification associated with the VM; a number of licensed cores allocated to the VM; an underlying clock frequency of a CPU associated with the VM; a location of an ISO image; a configuration file; an indicator of mounting a CD/DVD storage medium inside a VM; and a mapping of a mounted CD/DVD to a file system in a VM.

FIG. 6 illustrates a computer-readable medium (CRM) 600 which facilitates a common method for passing user data in a virtual environment, in accordance with an aspect of the present application. CRM 600 can be a non-transitory computer-readable medium or device storing instructions that when executed by a computer or processor cause the computer or processor to perform a method, including the methods and operations described herein.

CRM 600 may store instructions 610 to create, by a tool or program that runs on a hypervisor associated with a plurality of VMs, a data file comprising user data associated with deployment of a VM, as described above in relation to hypervisor 114 of FIG. 1, operation 302 of FIG. 3, and display screen 410 of FIG. 4.

CRM 600 may also store instructions 620 to obtain an output International Standard for Organization (ISO) image by creating, for the VM, a copy of a template ISO image, as described above in relation to hypervisor 114 of FIG. 1, operation 304 of FIG. 3, and display screen 410 of FIG. 4.

CRM 600 may also store instructions 630 to update the output ISO image based on the data file, wherein the output ISO image corresponds to a storage medium (e.g., a CD/DVD) accessible to a data-reading module of the VM. Updating the output ISO image based on the data file is described above in relation to hypervisor 114 of FIG. 1, operation 306 of FIG. 3, and display screen 410 of FIG. 4.

CRM 600 may store instructions 640 to deploy the VM based on the updated output ISO image, as described above in relation to communications 140, 142, and 144 by hypervisor 114 of FIG. 1, operation 308 of FIG. 3, and display screen 420 and sample Linux KVM code 422 of FIG. 4.

CRM 600 may also store instructions 650 to allow access by the VM to the user data by invoking a call to the data-reading module without requiring hypervisor-specific configuration information, as described above in relation to common data-reading module 121, 123, and 125 of, respectively, VMs 120, 122, and 124 of FIG. 1, operation 310 of FIG. 3, and display screen 430 of FIG. 4.

CRM 600 may include more instructions than those shown in FIG. 6. For example, CRM 600 may also store instructions to execute the operations described above in relation to: the environment of FIG. 1; the operations of flowchart 300 in FIG. 3; the operations associated with the display screens in FIG. 4; and instructions 518 of computer system 500 of FIG. 5.

In general, the disclosed aspects provide a method, computer system, and non-transitory computer-readable storage medium which facilitate a common method for passing user data in a virtual environment. In one aspect, the system creates, by a tool or program that runs on a hypervisor associated with a plurality of virtual machines (VMs), a data file comprising user data associated with deployment of a VM. The system obtains an output ISO image by creating, for the VM, a copy of a template ISO image. The system updates the output ISO image, the output ISO image corresponding to a storage medium (e.g., a CD/DVD) accessible to a data-reading module of the VM. The system deploys the VM based on the updated output ISO image. The system allows access by the VM to the user data by invoking a call to the data-reading module without requiring hypervisor-specific configuration information.

In a variation on this aspect, the user data comprises at least one of: an identifier of a parameter associated with the VM; a version of the parameter; a virtual local area network (VLAN) tag associated with the VM; an IP address of the VM; a length of a netmask associated with the VM; a model classification associated with the VM; a number of licensed cores allocated to the VM; or an underlying clock frequency of a central processing unit (CPU) associated with the VM.

In a further variation on this aspect, the system deploys the VM based on the updated output ISO image by: passing, to the VM, the user data via the updated output ISO image; and passing, to the VM, a location of the updated output ISO image in a configuration file. For example, hypervisor 114 in FIG. 1 may pass the user data to VM 124 by mounting a CD/DVD inside VM 124 using the updated output ISO image (as described above in relation to FIG. 4). Hypervisor 114 may also pass the location of that updated output ISO image in a configuration file, which may be sent to VM 124 during deployment.

In a further variation, the system deploys the VM based on the updated output ISO image by mounting the storage medium (e.g., CD/DVD) inside the VM. Mounting the storage medium inside the VM allows the VM to invoke the call to the data-reading module. The storage medium may be a CD/DVD and a user may deploy the VM by browsing to the location of the updated output ISO image and selecting that updated output ISO image to be mounted, as described above in relation to FIG. 4. Subsequent to the CD/DVD being mounted, the VM may access the user data by invoking the call to its data-reading module, as described above in relation to, e.g., communications 140, 142, and 144 and common data-reading modules 121, 123, and 125 of, respectively, VMs 120, 122, and 124 in FIG. 1.

In a further variation, the system creates a sample data file comprising sample user data in a format readable by the VM. The system performs a one-time generation of the template ISO image based on the sample data file. A tool or program running on the hypervisor may perform this one-time generation of the template ISO image based on sample user data, e.g., as described above in relation to FIG. 1.

In a further variation, the system generates all subsequent ISO images for a respective VM by updating the output ISO image based on a respective data file comprising respective user data to be used by a respective VM upon deployment of the respective VM. The system eliminates the need to create a new ISO image for deploying updated user data to a respective VM. Thus, a tool or program can create this template ISO image once, and the system can create, for the VM, a copy of that template ISO image. The copy may be referred to as the “output ISO image.” The result of updating this output ISO image based on user data may be referred to as the “updated output ISO image.”

In a further variation, the system updates the output ISO image based on the respective data file by: editing user data content in the output ISO image based on the respective user data for the respective VM; and renaming the updated output ISO image based on the respective VM. For example, the hypervisor may use a computer program to edit the output ISO image and rename that edited output ISO image based on the VM (as described above in relation to FIG. 1 and the renamed output ISO images CPU00.config.iso, CPU01.config.iso, and CPU02.config.iso).

Another aspect provides a computer system comprising at least one processing resource and a storage device (e.g., circuitry) storing instructions which when executed by the at least one processing resource comprises instructions to create, by a tool or program that runs on a hypervisor associated with a plurality of VMs, a data file comprising user data associated with deployment of a VM. The instructions are further to obtain an output ISO image by creating, for the VM, a copy of a template ISO image. The instructions are further to update the output ISO image based on the data file, wherein the output ISO image corresponds to a CD/DVD storage medium accessible to a data-reading module of the VM. The instructions are further to deploy the VM based on the updated output ISO image. The instructions are further to allow access by the VM to the user data by invoking a call to the data-reading module without requiring hypervisor-specific configuration information. The computer system may include a content-processing system which includes the above-described instructions and instructions to perform the operations described herein, including in relation to: the environment of FIG. 1; the operations of flowchart 300 in FIG. 3; the operations associated with the display screens in FIG. 4; and the instructions of CRM 600 of FIG. 6.

Yet another aspect provides a non-transitory computer-readable storage medium (CRM) storing instructions that when executed by a computer cause the computer to create, by a tool or program that runs on a hypervisor associated with a plurality of VMs, a data file comprising user data associated with deployment of a VM. The instructions are further to obtain an ISO image by creating, for the VM, a copy of a template ISO image. The instructions are further to update the output ISO image based on the data file, wherein the output ISO image corresponds to a CD/DVD storage medium accessible to a data-reading module of the VM. The instructions are further to deploy the VM based on the updated output ISO image. The instructions are further to allow access by the VM to the user data by invoking a call to the data-reading module without requiring hypervisor-specific configuration information.

In a variation on this aspect, the instructions stored by the CRM are further to migrate the VM to a different hypervisor. The instructions are further to deploy the VM based on a second updated output ISO image mounted during deployment by the different hypervisor. The instructions are further to invoke, by the VM, a call to the data-reading module based on the second updated output ISO image mounted during the deployment by the different hypervisor, thus achieving hypervisor independence. The CRM can also store instructions for executing the operations described above in relation to: the environment of FIG. 1; the operations of flowchart 300 in FIG. 3; the operations associated with the display screens in FIG. 4; and instructions 518 of computer system 500 of FIG. 5.

The foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
creating, by a tool or program that runs on a hypervisor associated with a plurality of virtual machines (VMs), a data file comprising user data associated with deployment of a VM;
obtaining an output International Standard for Organization (ISO) image by creating, for the VM, a copy of a template ISO image;
updating the output ISO image based on the data file, the output ISO image corresponding to a storage medium accessible to a data-reading module of the VM;
deploying the VM based on the updated output ISO image; and
allowing access by the VM to the user data by invoking a call to the data-reading module without requiring hypervisor-specific configuration information.

2. The method of claim 1, wherein the user data comprises at least one of:
an identifier of a parameter associated with the VM;
a version of the parameter;
a virtual local area network (VLAN) tag associated with the VM;
an Internet Protocol (IP) address of the VM;
a length of a netmask associated with the VM;
a model classification associated with the VM;
a number of licensed cores allocated to the VM; or
an underlying clock frequency of a central processing unit (CPU) associated with the VM.

3. The method of claim 1, wherein deploying the VM based on the updated output ISO image comprises:
passing, to the VM, the user data via the updated output ISO image; and
passing, to the VM, a location of the updated output ISO image in a configuration file.

4. The method of claim 1,
wherein deploying the VM based on the updated output ISO image comprises mounting the storage medium inside the VM, and
wherein mounting the storage medium inside the VM allows the VM to invoke the call to the data-reading module.

5. The method of claim 1, further comprising:
creating a sample data file comprising sample user data in a format readable by the VM; and
performing a one-time generation of the template ISO image based on the sample data file.

6. The method of claim 1, further comprising:
generating all subsequent ISO images for a respective VM by updating the output ISO image based on a respective data file comprising respective user data to be used by a respective VM upon deployment of the respective VM.

7. The method of claim 6, wherein updating the output ISO image based on the respective data file further comprises:
editing user data content in the output ISO image based on the respective user data for the respective VM; and
renaming the updated output ISO image based on the respective VM.

8. A computer system, comprising:
at least one processing resource; and
a storage device storing instructions which when executed by the at least one processing resource comprise instructions to:
create, by a tool or program that runs on a hypervisor associated with a plurality of virtual machines (VMs), a data file comprising user data associated with deployment of a VM;
obtain an output International Standard for Organization (ISO) image by creating, for the VM, a copy of a template ISO image;
update the output ISO image based on the data file, wherein the output ISO image corresponds to a storage medium accessible to a data-reading module of the VM;
deploy the VM based on the updated output ISO image; and
allow access by the VM to the user data by invoking a call to the data-reading module without requiring hypervisor-specific configuration information.

9. The computer system of claim 8, wherein the user data comprises at least one of:
an identifier of a parameter associated with the VM;
a version of the parameter;
a virtual local area network (VLAN) tag associated with the VM;
an Internet Protocol (IP) address of the VM;
a length of a netmask associated with the VM;
a model classification associated with the VM;
a number of licensed cores allocated to the VM; or
an underlying clock frequency of a central processing unit (CPU) associated with the VM.

10. The computer system of claim 8, wherein deploying the VM based on the updated output ISO image comprises:
passing, to the VM, the user data via the updated output ISO image; and
passing, to the VM, a location of the updated output ISO image in a configuration file.

11. The computer system of claim 8,
wherein deploying the VM based on the updated output ISO image comprises mounting the storage medium inside the VM, and
wherein mounting the storage medium inside the VM allows the VM to invoke the call to the data-reading module.

12. The computer system of claim 8, wherein the instructions are further to:
create a sample data file comprising sample user data in a format readable by the VM; and
perform a one-time generation of the template ISO image based on the sample data file.

13. The computer system of claim 8, wherein the instructions are further to:
generate all subsequent ISO images for a respective VM by updating the output ISO image based on a respective data file comprising respective user data to be used by a respective VM upon deployment of the respective VM.

14. The computer system of claim 13, wherein updating the output ISO image based on the respective data file further comprises:
editing user data content in the output ISO image based on the respective user data for the respective VM; and
renaming the updated output ISO image based on the respective VM.

15. A non-transitory computer-readable medium storing instructions which when executed by a processing resource comprise instructions to:
create, by tool or program that runs on a hypervisor associated with a plurality of virtual machines (VMs), a data file comprising user data associated with deployment of a VM;
obtain an output International Standard for Organization (ISO) image by creating, for the VM, a copy of a template ISO image;
update the output ISO image based on the data file, wherein the output ISO image corresponds to a storage medium accessible to a data-reading module of the VM;
deploy the VM based on the updated output ISO image; and
allow access by the VM to the user data by invoking a call to the data-reading module without requiring hypervisor-specific configuration information.

16. The non-transitory computer-readable medium of claim 15, wherein the instructions are further to:
migrate the VM to a different hypervisor;
deploy the VM based on a second updated output ISO image mounted during deployment by the different hypervisor; and
invoke, by the VM, a call to the data-reading module based on the second updated output ISO image mounted during the deployment by the different hypervisor.

17. The non-transitory computer-readable medium of claim 15, wherein deploying the VM based on the updated output ISO image comprises:
passing, to the VM, the user data via the updated output ISO image; and
passing, to the VM, a location of the updated output ISO image in a configuration file.

18. The non-transitory computer-readable medium of claim 15,
wherein deploying the VM based on the updated output ISO image comprises mounting the storage medium inside the VM, and
wherein mounting the storage medium inside the VM allows the VM to invoke the call to the data-reading module.

19. The non-transitory computer-readable medium of claim 15, wherein the instructions are further to:
create a sample data file with sample user data in a format readable by the VM;
perform a one-time generation of the template ISO image based on the sample data file; and
generate all subsequent ISO images for a respective VM by updating the output ISO image based on a respective data file comprising respective user data to be used by a respective VM upon deployment of the respective VM.

20. The non-transitory computer-readable medium of claim 19, wherein updating the output ISO image based on the respective data file further comprises:
editing user data content in the output ISO image based on the respective user data for the respective VM; and
renaming the updated output ISO image based on the respective VM.
